(19) United States
(12) Patent Application Publication
(10) Pub. No.: US 2016/0271923 A1
(43) Pub. Date: Sep. 22, 2016

(54) A DECORATIVE PANEL

(71) Applicant: TRESPA INTERNATIONAL B.V., Weert (NL)

(72) Inventors: ISABEL MARIA MARQUES DA SILVA MACEDO, WEERT (NL); MARCELLE HODGSON-STOKX, WEERT (NL)

(73) Assignee: Trespa International B.V., WEERT (NL)

(21) Appl. No.: 15/033,722

(22) PCT Filed: Oct. 31, 2014
(86) PCT No.: PCT/NL2014/050758

§ 371 Date: May 2, 2016

(30) Foreign Application Priority Data
Nov. 1, 2013 (NL) 2011719

(51) Int. Cl. B32B 29/00

(52) U.S. Cl. CPC B32B 29/005; B32B 2250/02; B32B 2250/26; B32B 2255/12; B32B 2255/26; B32B 2260/028; B32B 2260/046; B32B 2264/102; B32B 2307/412; B32B 2307/416; B32B 2307/4026; B32B 2451/00

(57) ABSTRACT

The present invention relates to a decorative panel comprising a core layer, a decorative layer applied to said core, and a transparent or translucent outermost layer applied to said decorative layer, said outermost layer consisting essentially of a synthetic resin, wherein said decorative layer is a IR reflectivity increasing layer. An object of the present invention is to provide a decorative panel that reflects a significant part of the IR light without affecting the visual appearance of the surface.

The present application relates to a decorative panel comprising a core /layer, a decorative layer applied to said core, and a transparent or translucent outermost layer applied to said decorative layer, said outermost layer consisting essentially of a synthetic resin.

Such decorative panels are known in the art. International application WO2010064895 in the name of the present applicant relates to a decorative film comprising a substrate, an intermediate layer, a decorative layer and a protective layer, respectively. According to WO2010064895 the composition of the protective layer is such that the protective layer is transparent and resistant to moisture and UV radiation, wherein the decorative layer contains pigments, which are brightly coloured and at least partially transparent, and the intermediate layer optionally contains pigments, preferably in a white or light colour, and protects the substrate against the inkjet-applied layer, i.e. the creation of a closed and smooth layer on the substrate. WO2010064895 further teaches that the substrate is selected from the group consisting of a resin-impregnated paper and a resin-impregnated non-woven.

From German Offenlegungsschrift DE 34 18 282 there is known a method for manufacturing a decorative panel, wherein a decorative layer is applied to an underlay, which decorative layer comprises a mixture of radiation-polymerisable components, after which the decorative layer is irradiated and pressed together with the underlay to obtain a scratch resistance of at least about 1.5 Newton.

From U.S. Pat. No. 4,789,604 in the name of the present applicant there is known a method for manufacturing a decorative panel, in which a liquid synthetic resin layer is a applied to a substrate layer, after which a film having a surface roughness is applied to the resin layer, said surface roughness being transferred to the resin layer, after which the resin layer is polymerised by exposure to radiation. Subsequently, the resin layer and the substrate are pressed together under elevated temperature conditions.

From European patent application No. 0 338 221 there is known a radiation-curable coating, to which coating, which is based on an acrylate mixture, matting agents are added in an amount of 20-60 weight percentage. Setting the matting degree by means of matting agents has appeared to be difficult in practice, because the matting agents adversely affect the crosslinking reaction of the matrix material, whilst in addition the use of matting agents has an adverse effect on the scratch resistance of a coating thus obtained.

From European patent application No. 0 706 834 there is known a method for producing a substrate material provided with a UV curable lacquer consisting of a lacquer based on an acrylate mixture, a UV initiator and other usual additives.

A decorative paper or a decorative film is used for decorating plate materials, which plate materials are based mainly on resin-impregnated wood fibres. Such a decorative panel is known from U.S. Pat. No. 3,789,604 and U.S. Pat. No. 4,801,495 in the name of the present applicant.

The process of manufacturing decorative paper by impregnation with a resin, followed by a thermal treatment, is known per se, for example from European patent application EP 0 022 153 and German Patentschrift DE 217 252. The following documents can furthermore be mentioned in connection with the impregnation of decorative paper with a resin: German Offenlegungsschrifts Nos. 2 727 312; 2 903 172; 2 224 732; 3 630 315; 3 541 187; 3 329 679 and 3 024 394; European patent publication EP 1 923 211 as well as U.S. Pat. No. 7,192,543

The traditional process of manufacturing HPL (high-pressure laminates) and HPL compact plates is carried out in a press under elevated temperature and pressure conditions.

In the field of energy absorption it is known that IR light comprises a large percentage of the solar energy that reaches the earth surface. The more an object absorbs this energy, the greater the heat build-up and the higher the energy consumption for cooling a building in hot climates are, although one assumes that this effect doesn't influence the colour of an object.

An object of the present invention is to provide a decorative panel that reflects a significant part of the IR light without affecting the visual appearance of the surface.

Another object of the present invention is to provide a decorative panel having dark coloured surfaces that typically absorb sunlight, being able to reflect sunlight and still keep the same colour specification.

Another object of the present invention is to improve IR radiation reflectivity of HPL uni-colours panels.

The present invention thus relates to a decorative panel comprising a core layer, a decorative layer applied to said core, and a transparent or translucent outermost layer applied to said decorative layer, said outermost layer consisting essentially of a synthetic resin, wherein said decorative layer is a IR reflectivity increasing layer, comprising a colored layer, wherein said colored layer is adjacent to the outermost layer and comprises pigments chosen from the group of the IR reflective type pigments and IR transmissive type pigments, or a combination thereof.

The present inventors found that by inserting an IR reflectivity increasing layer between the core layer and the outermost layer of a decorative panel it is possible to reflect a significant part of the IR light without affecting the visual appearance of the surface. This means that dark coloured surfaces, that typically absorb sunlight, will now be able to partly reflect sunlight and still keep the same colour specification. In addition, the present inventors found that by combining specific colour formulations, using pigments with high IR reflectivity/transmission and other reflective coatings/layers underneath the outermost coating, the IR radiation reflectivity of HPL uni-colours panels can be significantly improved. The layer construction of the decorative panel according to the present invention differs from the disclosure of International application WO2010064895 as discussed above mainly in its composition, namely pigments chosen from the group of the IR reflective type pigments and IR transmissive type pigments, or a combination thereof.

According to a preferred embodiment the IR reflectivity increasing layer further comprises at least one layer chosen from the group a white pigmented, synthetic resin impregnated decorative paper and a white pigmented synthetic resin, preferably the IR reflectivity increasing layer comprises both a white pigmented, synthetic resin impregnated decorative paper and a white pigmented synthetic resin, wherein said decorative paper is adjacent the core.

The IR reflectivity increasing layer comprises a coloured layer, wherein said coloured layer is adjacent to the outermost layer.

The coloured layer comprises pigments chosen from the group of the IR reflective type pigments and IR transmissive type pigments, or a combination thereof.

It is preferred that the white pigmented, synthetic resin layer comprises titanium dioxide in an amount of 25-50 wt. %, on basis of the total weight of that synthetic resin layer, wherein the total layer weight of said white pigmented, synthetic resin layer is preferably in a range of 20-150 g/m².

According to another embodiment the white pigmented, synthetic resin impregnated decorative paper comprises a synthetic resin chosen from the group of radiation polymerizing and thermosetting resins, especially phenol formaldehyde resin or urethane acrylates.

The coloured layer comprises pigments in a radiation-polymerized synthetic resin polymer. In a preferred embodiment the amount of said pigments in said colored layer is in a range of 5-120 g/m².

The total layer weight of the present IR reflectivity increasing layer is in a range of 40-600 g/m².

The total layer weight of the present transparent or translucent outermost layer is in a range of 10-100 g/m².

The core layer of the present decorative panel comprises at least one material selected from the group consisting of (a) wood, (b) a plurality of sheets of paper, plastic, or metal (c) nonwoven fabric, (d) fibre mats, especially thermo pressed stack of synthetic resin impregnated fibre-containing layers, (e) thermoplastic based with mineral fibres, (f) metal sheet and (g) minerals combined with thermosetting polymer.

Examples of preferred radiation-polymerized synthetic resin polymer are at least one oligomer selected from the group consisting of an epoxy-acrylate, an epoxy-methacrylate, a silicone-acrylate, a silicone-methacrylate, a polyester acrylate, a polyester methacrylate, a urethane acrylate, and a urethane methacrylate, especially an aliphatic urethane acrylate oligomer.

The present inventors found that the Total Solar Reflectance (TSR) of the present decorative panel, in %, which is the integration of total reflectance over the sunlight spectrum (280 nm-2500 nm) and calculated using reflectance values measured according to ASTM norm E903 and solar radiation values from ASTM norm G197-08, is preferably at least 28%, more preferably at least 35%, even more preferably at least 38%.

In the decorative panel according to the present invention the paper weight of the white pigmented, synthetic resin impregnated decorative paper is preferably between 20 and 300 g/m², more preferably between 60 and 260 g/m², based on the total weight of the synthetic resin impregnated decorative paper.

In a preferred embodiment of the present decorative panel examples of the IR reflective type pigments are Kronos White 2220 (manufactured by Kronos), Heucodur Yellow 156 (manufactured by Heubach) and Titanorange 6994 (manufactured by Broll), or a combination thereof.

In another preferred embodiment of the present decorative panel examples of the IR transmissive type pigments are Paliogen Black L0086 (manufactured by BASF), Irgazin Red BO (manufactured by BASF), Cinquasia Violet RT201 (manufactured by BASF) and Paliogen Blue 6385 (manufactured by BASF), or a combination thereof.

It is preferred that the presence of IR absorbing type pigments in the color layer is less than 5 g/m², wherein examples of the IR absorbing type pigments are Carbon Black 1020 (manufactured by Columbia Chemicals), Brown Bayferrox 645T (manufactured by Lanxess), Bayferrox Red 110 (manufactured by Lanxess), or a combination thereof.

The increase of IR reflectivity in a façade HPL panel according to the present invention makes the surface temperature of the panel decrease which means that less heat is transferred into the building. In hot climates this translates into a decrease of energy consumption for cooling.

HPL panels according to the present invention are produced using coatings that are radiation curable, that withstand high pressure/temperature in production processes and that resist extreme weathering conditions for at least 10 years. Such a process has been disclosed in U.S. Pat. No. 4,789,604 and U.S. Pat. No. 4,927,572, which documents are incorporated by reference.

The present invention is thus related with coatings that fulfill these conditions, combined with IR reflection properties for dark colours. The present invention is established on basis of the HPL technology/process, wherein the presence of dark underlayers (black core) is still effective, combined with radiation curable coatings, and the present panels find utilization in, inter alia, ventilated façade systems.

The invention will be explained in detail by means of the following examples. The percentages given are by weight.

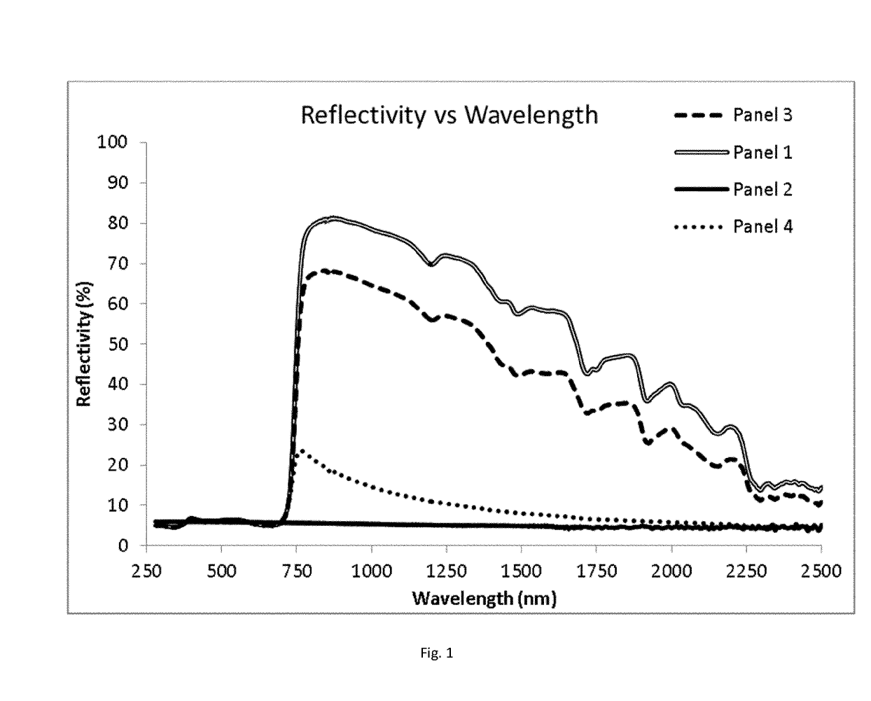

FIG. 1 shows the reflectivity (%) vs. the wavelength of several panels.

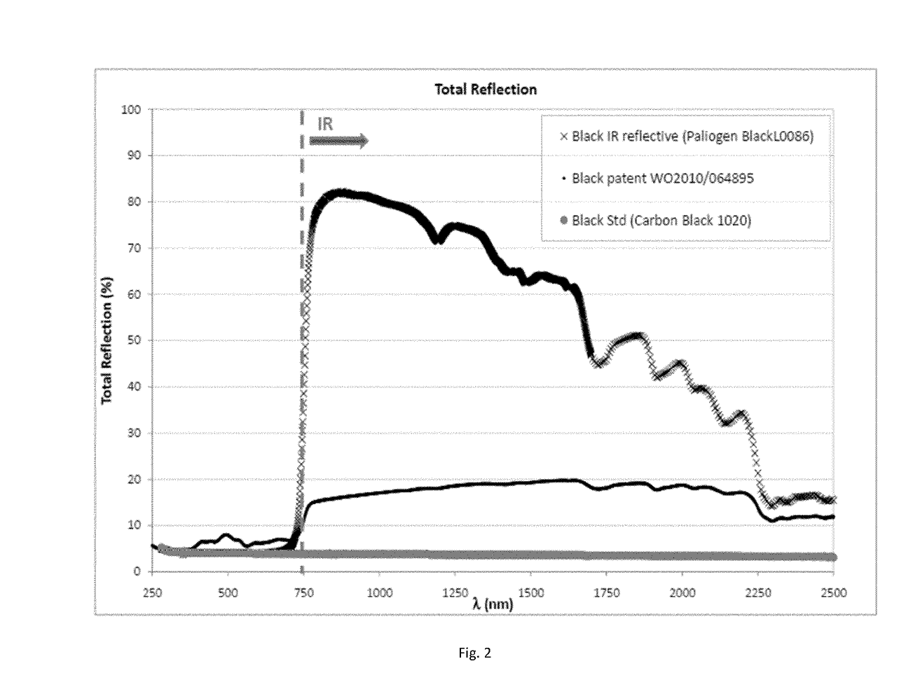

FIG. 2 shows the total reflection (%) vs. wavelength of several panels.

### EXAMPLES

The present inventors manufactured several HPL panels according to the process conditions disclosed in Example 1 of U.S. Pat. No. 4,927,572. The panels thus obtained can be subdivided in several individual layers, i.e. A, Core, B, White substrate paper, C, White underlayer, D, Coloured coating, and E, Top Coat.

The composition of each layer is as follows: A:Kraft paper or wood impregnated with phenol formaldehyde resin (45 g resin per 100 g paper), B: Decor paper based on 100% chemical pulp fibres, (typically the type of wood is eucalyptus), wherein white colour is obtained by using titanium dioxide (30 g titanium dioxide per 100 g paper), and paper is impregnated with phenol formaldehyde resin (58 g resin per 100 g paper), C: urethane acrylate resin with titanium dioxide (40 g titanium dioxide per 60 g resin), D: urethane acrylate resin with pigments formulation, and E: urethane acrylate resin.

The thickness of the core is between 2-30 mm, preferably between 8-10 mm. The weight of B was 123 g/m², weight of C was 70 g/m², weight of D was 70 g/m², and the weight of E was 27 g/m², all weight values based on total layer weight.

In the following Table the Total Solar Reflectance (TSR) is shown for several HPL panels. This is a comparison based on Total Solar Reflectance (TSR) in % which is the integration of total reflectance over the sunlight spectrum (280 nm-2500 nm) and is calculated using reflectance values measured according to ASTM norm E903 and solar radiation values from ASTM norm G197-08.

TABLE

| Panel | Construction of panel | TSR value |
|---|---|---|
| 1 | A, B, C, D, E | 36 |
| 2 | A, B, C, D, E | 5 |
| 3 | A, B, D, E | 30 |
| 4 | A, D, E | 10 |

From the table one can see that panel 1, i.e. a panel comprising all individual layers (A+B+C+D+E, wherein the pigments in layer D are of the type reflective and/or transmissive pigments), has a TSR=36, whereas panel 2, also comprising all individual layers but with a specific carbon black (Carbon Black 1020, Columbia Chemicals) shows a TSR=5. The present inventor is of the opinion that this decrease in TSR value is attributable to the specific optical properties (high absorbance of IR light) of the carbon black in the coloured layer D of panel 2. The pigments in panel 1 are Paliogen Black L0086 (BASF), Irgazin DPP red BO (BASF), Kronos White 2220 (Kronos) and Cinquasia Violet RT201D (BASF), which pigments can be qualified as IR reflective type pigments and IR transmissive type pigments. In panel 3 layer C is not present resulting in a TSR=30. In panel 4 layers B and C are not present resulting in a TSR=10.

The highest TSR value has been obtained with a panel comprising all individual layers in which the coloured layer comprises IR reflective type pigments and IR transmissive type pigments (panel 1), whereas the TSR value of a panel without layer C shows a reduction of the TSR value to a value of TSR=30.

In FIG. 1 the experimental results for the reflectivity vs. wavelength for each panel 1, 2, 3, and 4 can be found. These data clearly demonstrate that the panels according to the present invention show an improved IR radiation reflectivity of HPL uni-colours panels.

The present inventors have also conducted a reflectivity measurement for a sample with a build-up of layers according to WO2010/064895. In FIG. 2 one can see this measurement and the comparison, for the similar colour, with the measurement for the present invention (IR reflection improved) and also for a standard black panel (manufactured by Trespa). From the graph shown in FIG. 2 one can deduce that with the composition of the coloured layer from WO2010/064895 the reflectivity in the IR part of the spectrum is much lower than the one from the present invention.

1. A decorative panel comprising a core layer, a decorative layer applied to said core, and a transparent or translucent outermost layer applied to said decorative layer, said outermost layer comprising a synthetic resin, wherein said decorative layer is an infrared reflectivity increasing layer, comprising a colored layer, wherein said colored layer is adjacent to the outermost layer and comprises an infrared reflective pigment or an infrared transmissive pigement, or a combination thereof.

2. The decorative panel as claimed in claim 1 , wherein said infrared reflectivity increasing layer further comprises at least one layer chosen from a white pigmented, synthetic resin impregnated decorative paper and a white pigmented synthetic resin.

3. The decorative panel according to claim 2, wherein said infrared reflectivity increasing layer comprises both a white pigmented, synthetic resin impregnated decorative paper and a white pigmented synthetic resin, wherein said decorative paper is adjacent the core.

4. The decorative panel according to claim 1, wherein said white pigmented, synthetic resin layer comprises titanium dioxide in an amount of 25 50 wt. %, on basis of the total weight of said layer.

5. The decorative panel according to claim 1 wherein the total layer weight of said white pigmented, synthetic resin layer is in a range of 20-150 g/m².

6. The decorative panel according to claim 2, wherein said white pigmented, synthetic resin impregnated decorative paper comprises a synthetic resin chosen from the group of radiation polymerizing and thermosetting resins, especially phenol formaldehyde resin or urethane acrylates.

7. The decorative panel as claimed in claim 1, wherein said colored layer comprises said pigments in a radiation-polymerized synthetic resin polymer.

8. The decorative panel as claimed in claim 1, wherein the amount of said pigments in said colored layer is in an range of 5-120 g/m².

9. The decorative panel according to claim 1, wherein the total layer weight of said infrared reflectivity increasing layer is in a range of 40-600 g/m².

10. The decorative panel as claimed in claim 1, wherein the total layer weight of said transparent or translucent outermost layer is in a range of 10-100 g/m².

11. A The decorative panel as claimed in claim 1, wherein said core layer comprises at least one material selected from the group consisting of (a) wood, (b) a plurality of sheets of paper, plastic, or metal (c) nonwoven fabric, (d) fiber mats (e) thermoplastic based with mineral fibers, (f) metal sheet and (g) minerals combined with thermosetting polymer.

12. A The decorative panel as claimed claim 6, wherein said radiation-polymerized synthetic resin polymer comprises at least one oligomer selected from the group consisting of an epoxy-acrylate, an epoxy-methacrylate, a silicone-acrylate, a silicone-methacrylate, a polyester acrylate, a polyester methacrylate, a urethane acrylate, and a urethane methacrylate, especially an aliphatic urethane acrylate oligomer.

13. A The decorative panel as claimed in claim 1, wherein the Total Solar Reflectance (TSR) of said decorative panel, in %, which is the integration of total reflectance over the sunlight spectrum of 280 nm-2500 nm and calculated using reflectance values measured according to ASTM norm E903 and solar radiation values from ASTM norm G 197-08, is at least 28%.

14. A The decorative panel according to claim 1, wherein the paper weight of said white pigmented, synthetic resin impregnated decorative paper is between 20 and 300 g/m², based on the total weight of the synthetic resin impregnated decorative paper.

15. A The decorative panel according to claim 1, wherein said infrared reflective type pigments comprise White 2220, Heucodur Yellow 156, Titanorange 6994, or a combination thereof.

16. A The decorative panel according to claim 1, wherein said infrared transmissive type pigments comprise Paliogen Black L0086, Irgazin Red BO, Cinquasia Violet RT201, and Paliogen Blue 6385, or a combination thereof.

17. A The decorative panel according to claim 1, wherein in said color layer the presence of infrared absorbing type pigments is less than 5 g/m².

18. A The decorative panel according to claim 17, wherein said infrared absorbing type pigments comprise Carbon Black 1020, Brown Bayferrox 645T, Bayferrox Red 110, or a combination thereof.
